(19) United States
(12) Patent Application Publication
(10) Pub. No.: US 2007/0204915 A1
(43) Pub. Date: Sep. 6, 2007

(54) Combined Pressure Reducing and Shut-Off Valve

(75) Inventors: Masahiko Kimbara, Kariya-shi (JP); Nobuo Kobayashi, Toyota-shi (JP); Nobuyuki Ogami, Anjo-shi (JP); Akira Yamashita, Toyota-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, AICHI (JP)

(21) Appl. No.: 11/659,740

(22) PCT Filed: Aug. 26, 2005
(86) PCT No.: PCT/JP05/16068

§ 371 Date: Feb. 8, 2007

(30) Foreign Application Priority Data
Aug. 26, 2004 (JP) 2004-247361

(51) Int. Cl. F16K 31/14

(52) U.S. Cl. 137/495; 137/505.42

(57) ABSTRACT

A pressure-reducing valve is disclosed which is capable of preventing leakage of a fluid from a passage aperture in a state in which the passage aperture is closed by a valve body. The pressure-reducing valve is structured such that a plunger is moved upward due to a biasing force of a shut spring when a magnetic field generated around and inside a solenoid body is released. Thus, the valve body is pushed up from below by a pressing portion of the plunger with a pressing force based on the biasing force of a shut spring. Due to the valve body being pushed up, the upper end of the valve body is placed in close contact with the inner peripheral portion of the passage aperture so that the passage aperture is closed. In this manner, leakage of hydrogen gas from a primary pressure chamber to a secondary pressure chamber (leakage of the gas pressure) can be prevented with certainty, and thus an unintentional increase of the pressure at the secondary pressure chamber side can be prevented with certainty.

### BACKGROUND OF THE INVENTION

1. Field of the Invention

The present invention generally relates to a pressure-reducing valve and more particularly to a pressure-reducing value in which a secondary pressure is reduced relative to a primary pressure.

2. Description of the Related Art

In recent years, in the development of so-called fuel cells suitable for practical use as motive energy sources for motor vehicles has been promoted. Such a fuel cell is a system in which electric power is generated through use of an electrochemical reaction of hydrogen and oxygen, and an example of which is a proton-exchange membrane fuel cell which includes a stack formed by layering a number of cells. Each of the cells forming the stack includes an anode (fuel pole) and a cathode (air pole) between which is interposed a solid polymer electrolyte membrane containing a sulfonic acid group as an ion exchange group.

To the anode is supplied a fuel gas containing hydrogen, while to the cathode is supplied a gas containing oxygen as an oxidizer such as for example air. Since the fuel gas is supplied to the anode, the hydrogen contained in the fuel gas is reacted with the catalyst of a catalyst layer constituting the anode, and thus hydrogen ions are produced. The hydrogen ions thus produced penetrate through the solid polymer electrolyte membrane and are subjected to an electrochemical reaction with oxygen at the cathode.

Meanwhile, for fuel cells using a fuel gas containing hydrogen as mentioned above, various fuel forms, such as liquids, solids and gases, to mount the fuel have been studied. As the most simplified and convenient form of such fuel forms, a method in which hydrogen gas is stored at high pressure or a method in which compressed natural gas (CNG) is stored at high pressure and reformed into hydrogen-rich gas mixed with carbon dioxide, which in turn is fed to a fuel cell, has been conceived.

Hydrogen gas or compressed natural gas such as mentioned above is voluminous at low pressure. For this reason, such a gas, when mounted in a limited space of a motor vehicle, is stored in a tank made of a carbon fiber composite material at an extra high pressure such as 35 MPa or 70 MPa.

In a fuel cell system using high-pressure hydrogen as the fuel, hydrogen and air are fed while being separated by an electrolyte membrane of several 10 microns thickness. Thus, it is required that the pressure difference between the hydrogen and the air be minimized. Accordingly, if the pressure of the air is increased, then the compression power is increased, thus resulting in a decrease in the overall efficiency. For this reason, it is a common practice that a solid polymer based fuel cell is operated in a state in which the pressure of hydrogen is reduced down to 0.3 MPa.

Thus, as described above, hydrogen stored in a tank at an extra high pressure such as 35 MPa or 70 MPa is pressure-reduced by a pressure-reducing valve such as disclosed in JP-A No. 11-16652, for example, and then fed to a fuel cell.

Further, also in the case where the above-mentioned compressed natural gas (CNG) is used, it is conceived that, as in the case of hydrogen, the compressed natural gas (CNG) which is stored in a tank at extra-high pressure is pressure-reduced by a pressure-reducing valve and then fed to a fuel cell, since there is a tendency that a reaction is promoted when reformed mixture gas is low-pressurized.

Such a pressure-reducing valve which is used with a gas tank is structured such that the valve body is pressed by the piston so as to be spaced apart from the passage aperture and thus the passage aperture is opened when a composite force resulting from a combination of the primary pressure chamber located on the valve body side from the passage aperture (vent aperture) and the biasing force of the valve supporting spring is smaller than the biasing force of the pressure regulating spring for biasing the piston provided on the side opposite to the valve body across the passage aperture.

Further, when the passage aperture is opened and thus gas is caused to flow in the secondary pressure chamber on the piston from the passage aperture, the gas pressure in the secondary pressure chamber acts on the piston at the side opposite to that of the biasing force of the pressure regulating spring. For this reason, the force which causes the piston to be biased toward the passage aperture is decreased. Thus, the pressing force which the piston imparts to the valve body is decreased such that the valve body is caused to approach the passage aperture due to the above-mentioned composite force and close the passage aperture.

In this manner, the pressure of the gas is reduced, based on a balance of the force imparted to the piston on the primary pressure chamber side and the force imparted to the valve body on the secondary pressure chamber side, so as to be supplied from the secondary pressure chamber to an external portion such as a fuel cell system, for example.

Meanwhile, for example, when the fuel cell system is stopped and the fuel gas flow is interrupted by closing an electromagnetic valve provided at a downstream side of the pressure-reducing valve, the pressure-reducing valve operates structurally such that the valve body closes the passage aperture in a state in which the touching pressure of the valve body is “0”.

Realistically, in such a state in which the touching pressure is “0”, the fuel gas is allowed to leak from the primary pressure chamber side to the secondary pressure chamber side, and thus the gas pressure in the secondary pressure chamber is increased. Due to the gas pressure in the secondary pressure chamber being increased, the pressure with which the valve body closes the passage aperture is also increased so that the passage aperture is hermetically closed. However, since the operation of the fuel cell system is restarted in a state in which the gas pressure in the secondary pressure chamber has been increased, when the electromagnetic valve is opened, a high-pressure wave is momentarily caused to pass through the piping and flow in the downstream fuel cell system. Due to such a high-pressure wave flowing in the fuel cell system, there is a possibility that the components of the fuel cell system are damaged and/or an abnormal sound is heard around the fuel cell system.

Further, even if an electromagnetic valve is provided at an upstream side of the pressure-reducing valve, since the secondary pressure is increased due to leakage from the pressure-reducing valve of the high-pressure gas between the pressure-reducing valve and the electromagnetic valve, there is a possibility that a problem similar to the above occurs.

### SUMMARY OF THE INVENTION

In view of the foregoing, the present invention provides a pressure-reducing valve capable of preventing leakage of a fluid from a passage aperture in a state in which the passage aperture is closed by a valve body.

A first aspect of the present invention provides pressure-reducing valve, including: a valve body provided at a more upstream position from a passage aperture through which a fluid flows, as viewed in a direction of the fluid flow, in a manner to be movable into and out of contact with the passage aperture, the valve body being structured so as to be biased toward the passage aperture due to a first biasing force directed toward the passage aperture and moved in a direction to approach the passage aperture due to a primary pressure side composite force resulting from a combination of the force due to a primary pressure which is a pressure of the fluid at a more upstream position than the passage aperture and the first biasing force, thereby closing the passage aperture; a pressure regulating member provided at a downstream position from the passage aperture as viewed in a direction of the fluid flow and on an opposite side to the valve body across the passage aperture in a manner so as to be movable toward and away from the passage aperture, the pressure regulating member being structured so as to be biased due to a second biasing force directed in a direction towards the passage aperture and causing the valve body to be spaced apart from the passage aperture when a secondary pressure side composite force resulting from a combination of the second biasing force and the resultant force due to the pressure difference between a secondary pressure which is a pressure of the fluid at a more downstream position of the fluid flow than the passage aperture and the atmospheric pressure, exceeds the primary pressure side composite force; and interfering means capable of interfering and releasing the interference with the valve body and restricting movement of the valve body in a direction spacing apart from the passage aperture in a state of interference with the valve body.

A second aspect of the present invention provides a pressure-reducing valve, comprising: a valve body provided at a more upstream position from a passage aperture through which a fluid flows, as viewed in a direction of the fluid flow, in a manner to be movable into and out of contact with the passage aperture, the valve body being structured so as to be biased toward the passage aperture due to a first biasing force directed toward the passage aperture and moved in a direction to approach the passage aperture due to a primary pressure side composite force resulting from a combination of the force due to a primary pressure which is a pressure of the fluid at a more upstream position than the passage aperture and the first biasing force, thereby closing the passage aperture; a pressure regulating member provided at a downstream position from the passage aperture as viewed in the direction of the fluid flow and on an opposite side to the valve body across the passage aperture in a manner so as to be movable toward and away from the passage aperture, the pressure regulating member being structured so as to be biased due to a second biasing force directed in a direction toward the passage aperture and causing the valve body to be spaced apart from the passage aperture when a secondary pressure side composite force resulting from a combination of the second biasing force and the resultant force due to the pressure difference between a pressure of the fluid at a more downstream position of the fluid flow than the passage aperture and the atmospheric pressure, exceeds the primary pressure side composite force; and interfering means capable of interfering and releasing the interference with the valve body and restricting movement of the valve body in a direction spacing apart from the passage aperture in a state of interference with the valve body, the interfering means comprising an interfering member provided in a manner so as to be movable into and out of contact with the valve body at a side of the valve body opposite to the passage aperture along a direction that the valve body is moved into and out of contact with the passage aperture, the interfering member being structured so as to contact and interfere with the valve body through movement in a direction approaching the valve body, and driving means for moving the interfering member in at least one of a direction approaching the valve body or a direction departing from the valve body.

A third aspect of the present invention provides A pressure-reducing valve, comprising: a valve body provided at a more upstream position from a passage aperture through which a fluid flows, as viewed in a direction of the fluid flow, in a manner to be movable into and out of contact with the passage aperture, the valve body being structured so as to be biased toward the passage aperture due to a first biasing force directed toward the passage aperture and moved in a direction to approach the passage aperture due to a primary pressure side composite force resulting from a combination of the force due to a primary pressure which is a pressure of the fluid at a more upstream position than the passage aperture and the first biasing force, thereby closing the passage aperture; a pressure regulating member provided at a downstream position from the passage aperture as viewed in the direction of the fluid flow and on an opposite side to the valve body across the passage aperture in a manner so as to be movable toward and away from the passage aperture, the pressure regulating member being structured so as to be biased due to a second biasing force directed in a direction toward the passage aperture and causing the valve body to be spaced apart from the passage aperture when a secondary pressure side composite force resulting from a combination of the second biasing force and the resultant force due to the pressure difference between a pressure of the fluid at a more downstream position of the fluid flow than the passage aperture and the atmospheric pressure, exceeds the primary pressure side composite force; and interfering means capable of interfering and releasing the interference with the valve body and restricting movement of the valve body in a direction spacing apart from the passage aperture in a state of interference with the valve body, the interfering means comprising an interfering member provided in a manner so as to be movable into and out of contact with the valve body at a side of the valve body opposite to the passage aperture along a direction that the valve body is moved into and out of contact with the passage aperture, the interfering member being structured so as to contact and interfere with the valve body through movement in a direction approaching the valve body, and driving means for moving the interfering member in at least one of a direction approaching the valve body or a direction departing from the valve body wherein the interfering means presses the valve body toward the passage aperture in a state of interference with the valve body biasing means that causes the interfering member to be biased either in a direction approaching the valve body or in a direction departing from the valve body, wherein the driving means causes the interfering member to be moved only in a direction substantially opposite to the direction in which the interfering member is biased by the biasing means, and wherein the interfering means interferes with the valve body in at least one of the states from the group consisting of a state in which a flow rate of the fluid passing through the passage aperture is equal to or lower than a preset predetermined value, a state in which the pressure at the downstream side of the passage aperture is higher than a predetermined value, and a state in which the pressure at the downstream side of the passage aperture is lower than a predetermined value.

Other aspects, features and advantages of the present invention will become apparent from the following description taken in conjunction with the accompanying drawings.

### BRIEF DESCRIPTION OF THE DRAWINGS

FIG. 1 is a sectional view showing the structure of a pressure-reducing valve according to a first embodiment of the present invention;

FIG. 2 is a sectional view, corresponding to FIG. 1, showing a state in which an interfering means is makes no interference with a valve body;

FIG. 3 is a view showing a state in which forces work on the valve body and piston;

FIG. 4 is a block diagram schematically showing the structure of a fuel cell system;

FIG. 5 is a block diagram schematically showing the structure of a control system for the pressure-reducing valve according to the first embodiment of the present invention.

FIG. 6 is a sectional view showing the structure of a pressure-reducing valve according to a second embodiment of the present invention.

### DETAILED DESCRIPTION OF THE INVENTION

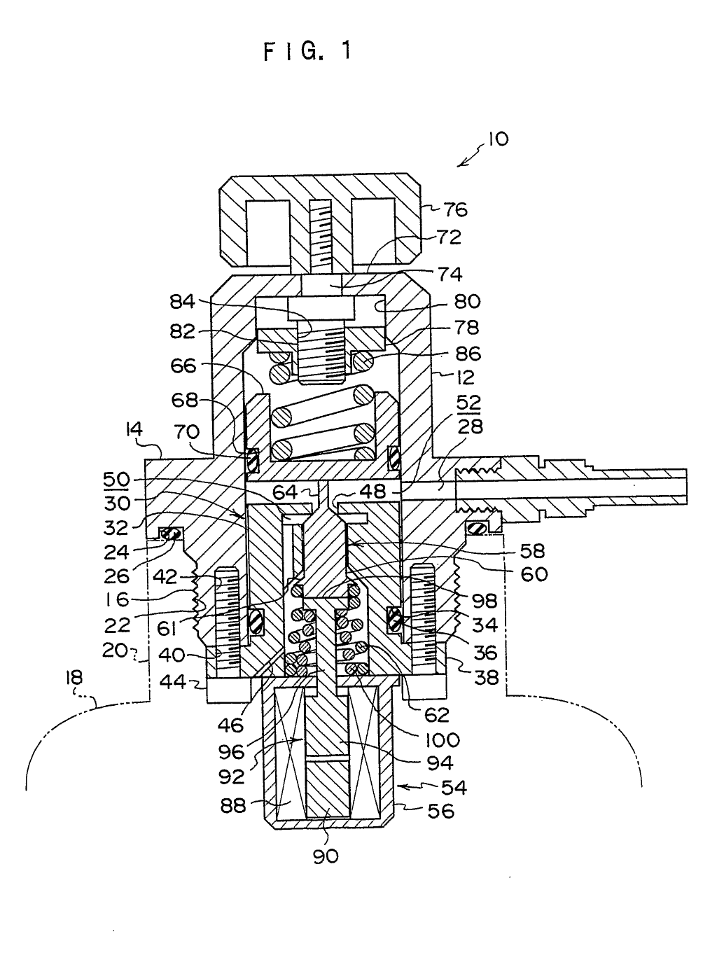

Referring to FIG. 1, there is shown in a sectional view the pressure-reducing valve 10 according to a first embodiment of the present invention.

As shown in FIG. 1, the pressure-reducing valve 10 includes a body 12 which is configured in a bottomed cylindrical shape closed at an upper end as viewed in FIG. 1. A flange portion 14 extends from the outer circumference of a vertically intermediate portion of the body 12. A male screw 16 is formed on the outer circumference of the body 12 below the flange portion 14.

The male screw 16 is configured such that it can mesh with a female screw 22 formed in a mouth ring portion 20 of a tank 18. The opening end of the mouth ring portion 20 can be closed by means of the male screw 16 being meshed with the female screw 22.

Further, an annular groove 24, which is concentric with respect to the male screw 16, is formed in the lower surface of the flange portion 14.

In the annular groove 24 is fitted an annular sealing member 26 such as O-ring, gasket or the like. With the male screw 16 meshed with the female screw so that the lower end of the body 12 is fitted into the mouth ring portion 20 to a predetermined extent, the sealing member 26 is closely contacted by the upper end surface of the mouth ring portion 20 and the bottom portion of the annular groove 24. Thus, the mouth ring portion 20 and the body 12 are sealed together.

Further, a feed portion 28 is formed in part of the flange portion 14. The feed portion 28 is formed by an aperture which extends through the body 12 in a radial direction of the flange portion 14 and through which the interior and the exterior of the body 12 are communicated so that a gas (hydrogen gas) which has passed through the inside of the body 12 is permitted to flow through the feed portion 28 so as to be delivered outside the pressure-reducing valve 10.

Further, the body 12 is provided with a valve mechanism 30 which includes a frame 32. The frame 32 is formed in a column-like shape whose outer diameter is approximately equal to the inner diameter of the body 12 (to be precise, the outer diameter of the frame 32 is slightly smaller than the inner diameter of the body 12 so that the frame 32 can be fitted in the body 32). An annular groove 34 is formed in the outer circumference of the frame 32 in the vicinity of the lower end portion thereof.

In the annular groove 34 is fitted a sealing member 36 such as O-ring, gasket or the like. In a state in which the frame 32 is inserted in the body 12 through the lower open end thereof, the sealing member 36 is placed in close contact with both the inner circumferential portion of the body 12 and the bottom portion of the annular groove 34 so that the inner circumferential portion of the body 12 and the outer circumferential portion of the frame 32 are sealed together.

Further, a flange portion 38 extends from the lower end of the frame 32 in a radially outward direction of the frame 32 The flange portion 38 is placed in opposing relationship to the lower end of the body 12 when the frame is inserted in the body 12. Further, the flange portion 38 is formed with through apertures 40, and the body 12 is formed with threaded apertures 42 in alignment with the through apertures 40.

Bolts 44 which serve as clamping means are inserted through the through apertures 40 and screwed into the threaded apertures 42 so that the flange portion 38 is securely clamped to the body 12 in a manner in which the flange portion 38 is placed in close contact with the lower surface of the body 12. Further, a vent portion 46 is formed in the frame 32.

The interior and the exterior of the frame 32 are in communication through the vent portion 46, and when the body 12 is fitted in the mouth ring portion 20, the interior of the frame 32 and the interior of the tank 18 are in communication through the vent portion 46. Further, a passage aperture 48 is formed in the upper end portion of the frame 32. A primary pressure chamber 50 which is an internal space of the frame 32 and a secondary pressure chamber 52 which is an internal space of the body 12 above the frame 32 are in communication through the passage aperture 48.

Further, a solenoid 54 which constitutes interfering means as driving means described later is securely fixed to the lower end of the primary pressure chamber 50 of the frame 32. Further, a valve body 58 is accommodated in the primary pressure chamber 50.

The valve body 58 includes a main body 60 which is configured in an approximately cylindrical shape whose longitudinal axis extends along a vertical direction. A retaining flange 61 is provided on the outer circumference of an axially intermediate portion of the main body 60.

A valve supporting spring 62, which is adapted to serve as first biasing means, is provided between the lower surface of the retaining flange 61 and a housing 56 of the solenoid 54. The main body 60 is biased in an upward direction, i.e. in a direction to approach the upper bottom portion of the frame 32 in which the passage aperture 48 is formed, due to a biasing force F1 of the valve supporting spring 62 (hereinafter, the biasing force F1 of the valve supporting spring 62 will be referred to as “first biasing force F1”).

Further, the upper end portion of the main body 60 is configured in a conical shape such that the outer diameter thereof is gradually decreased toward the top, and structured such that it is opposed to the passage aperture 48 from below and fitted in the passage aperture 48 thereby making it possible to close the passage aperture 48. Moreover, a pressed piece 64 is integrally provided on the upper end portion of the main body 60.

The pressed piece 64 has an outer diameter that is sufficiently smaller that the inner diameter of the passage aperture 48 so that the fore end portion thereof (portion opposite to the main body 60) protrudes into the secondary pressure chamber 52 through the passage aperture 48. A piston 66 adapted to serve as a pressure regulating member is provided in the secondary pressure chamber 52 in association with the pressed piece 64.

The piston 66 is configured in a bottomed cylindrical shape which is open upward, and vertically slidable in a cylinder defined by the secondary pressure chamber 52. An annular groove 68 which is concentric with respect to the piston 66 is formed in the outer circumference of the piston 66

In the annular groove 68 is fitted an annular sealing member 70 such as O-ring or gasket. The sealing member 70 is placed in close contact with both the inner circumference of the body 12 and the bottom of the annular groove 68, and structured so as to seal between the outer circumference of the piston 66 and the inner circumference of the body 12.

In an upper base portion 72 of the body 12, a shaft 74 is provided which extends through the upper base portion 72 in a manner to be substantially coaxial with respect to the body 12. Although rotatably supported by the upper base portion 72, the shaft is prevented from sliding along the vertical direction.

Further, a grip portion 76 is provided on the upper end portion of the shaft 74. When the grip portion 76 is gripped, it is structured so that the shaft 74 can be rotated about its axis by imparting to the grip portion 76 a rotational force about an axis whose direction conforms to the vertical direction.

Further, a spring retaining plate 78 whose configuration is non-circular (square in this embodiment) is provided in the body 12. The spring retaining plate 78 is fitted in a guide portion 80 near the upper base portion 72 inside the body 12 in a manner oriented such that the thickness-wise direction thereof conforms to the vertical direction. The guide portion 80 is configured in the form of an aperture portion having a shape that corresponds to that of the spring retaining plate 78 (i.e., square in this embodiment. Being fitted in the guide portion 80, the spring retaining plate 78 is prevented from rotating while it is slidable in the vertical direction. Further, a female screw 82 is formed in the spring retaining plate 78.

Screwed into the female screw 82 is a male screw 84 formed on the shaft 74 in the vicinity of the lower end portion thereof. Thus, it is structured so that the spring retaining plate 78 is supported by the shaft 74 in a manner in which the spring retaining plate 78 is slid upward or downward due to rotation of the shaft 74 about its own axis.

Further, a pressure regulating spring 86, which is adapted to serve as second biasing means, is provided between an inner bottom portion of the above piston 66 and the spring retaining plate 78. The pressure regulating spring 86 has a lower end placed in contact with the inner bottom portion of the piston 66 and an upper end placed in contact with the spring retaining plate 78 and causes the piston 66 to be biased in a downward direction, i.e., in a direction to approach the upper base portion of the frame 32 in which the passage aperture 48 is formed, due to a biasing force F2 of the pressure regulating spring 86 (hereinafter, the biasing force F2 of the pressure regulating spring 86 will be referred to as “second biasing force”).

Meanwhile, a solenoid body 88 is provided in the above housing 56. The solenoid body 88 is a coil which, when energized, generates a magnetic field in a surrounding area and which is oriented such that the axis thereof is directed in the vertical direction in the case where the configuration of the solenoid body 88 is regarded as cylindrical. A core 90 is provided inside the solenoid body 88.

The core 90 is made of a ferromagnetic material and when magnetized by the magnetic field generated by the solenoid body 88, becomes a magnet whose poles are oriented in the axial direction of the solenoid body 88. Further, a plunger 92 which is adapted to form interfering means as a pressing member is provided inside the solenoid body 88 and above the core 90.

The plunger 92 includes a base portion 94 which can be moved into and out of contact with the core 90 along the axial direction of the solenoid body 88 inside the solenoid body 88. A rod-like shaft portion 96 is provided in a manner to protrude from the end surface of the base portion 94 opposite to the core 90. The shaft portion 96 extends through the housing 56 and into the interior of the frame 32. Further, a pressing portion 98 is provided on the fore end of the shaft portion 96 (the end portion opposite to the base portion 94).

The pressing portion 98 is formed in a disk-like shape, having a larger diameter than that of the shaft portion 96, integrally and coaxially with the shaft portion 96, and disposed in opposing relationship to the lower surface of the main body 60 of the valve body 58. Further, a shut spring 100 which is adapted to serve as third biasing means (“biasing means” referred to in the claims) is provided between the rear surface of the pressing portion 98 (the shaft portion 96 side surface) and the housing 56 which closes the frame 32.

The shut spring 100 is disposed on the housing 56 in a state in which the lower end thereof contacts the housing 56 and the upper end thereof contacts the rear surface of the pressing portion 98. Thus, the pressing portion 98, and in turn the plunger 92, is biased in an upward direction, i.e., in a direction to approach the lower surface of the main body 60 (valve body 58) due to a biasing force F3 of the shut spring 100 (hereinafter, the biasing force F3 of the shut spring 100 will be referred to as “third biasing force F3”).

In a state in which no other force than the third biasing force acts on the plunger 92, as shown in FIG. 1, the pressing portion 98 is disposed in contact with the lower surface of the main body 60 (valve body 58) and pushes up the valve body 58 from below with a pressing force based on the third biasing force F3.

Next, description will be made of an application example of the inventive pressure-reducing valve.

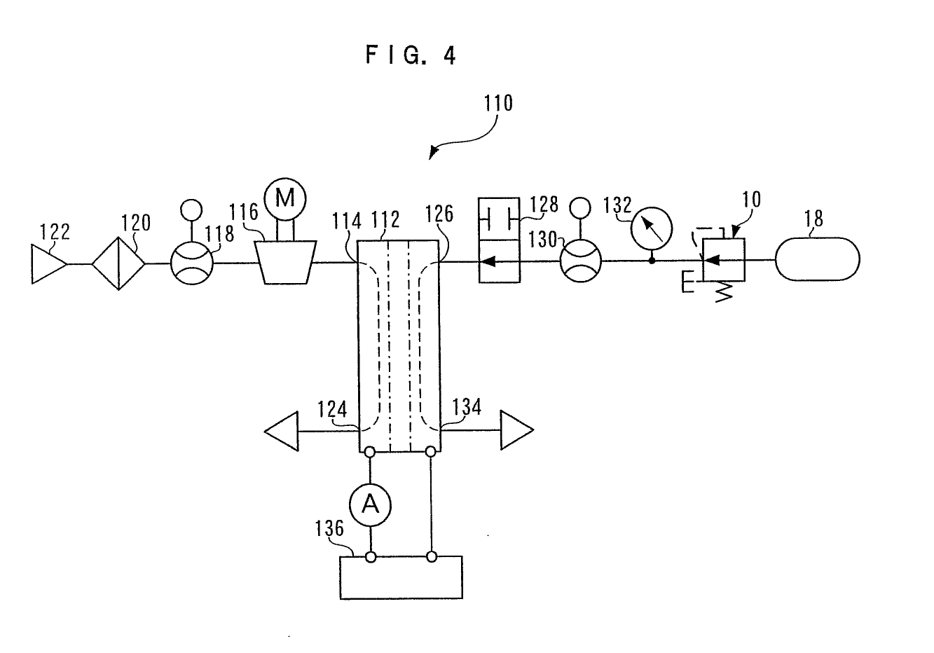

Referring to FIG. 4, there is shown, in a block diagram, the structure of a fuel cell system 110 to which the pressure-reducing valve 10 is applied.

As shown in this figure, the fuel cell system 110 has a stack 112. The stack 112 includes a plurality of cells each comprising: an electrolyte membrane formed of a solid polymer containing a sulfonic acid group as an ion exchange group; an anode side plate-like separator provided on one side in the thickness-wise direction of the electrolyte membrane; a cathode side plate-like separator provided on the other side in the thickness-wise direction of the electrolyte member; a gas diffusion layer formed of carbon paper or carbon cloth having excellent conductivity and air permeability; and a catalytic layer formed in a matrix-like form of carbon carrying an appropriate mixture of platinum and a platinum system alloy as catalyst, and an electrolyte, the catalytic layer being provided in the electrolyte membrane and each gas diffusion layer.

The stack 112 is formed with a cathode side gas feed port 114. The cathode side gas feed port 114 is connected to an air inlet port 122 via a pump 116, a flow meter 118, and a filter 120, and configured so as to be able to inhale the atmosphere (air) based on the operation of the pump 116 and feed the air as a cathode gas to the cathode side separator provided in the interior of the stack 112.

Further, the stack 112 is formed with a cathode side gas discharge port 124 which is configured so as to be able to discharge the ambient air used in the stack 112 to the outside as exhaust gas

Still further, the stack 112 is formed with an anode side gas feed port 126. The anode side gad feed portion 126 is coupled to the pressure-reducing valve 10 via a valve 128, a flow meter 130, and a pressure gage 132, and further coupled via the pressure-reducing valve 10 to the tank 18 in which high-pressure hydrogen gas is stored (actually, the pressure-reducing valve 10 is connected to the mouth ring portion 20 of the tank 18 as mentioned above).

Furthermore, the stack 112 is formed with an anode side gas discharge port 134. When the valve 128 is opened at the anode side gas feed port 126, the hydrogen gas of the tank 18 is pressure-reduced by the pressure-reducing valve 10, and then fed as anode gas from the anode side gas feed port 126 to the anode side separator of the cells provided in the stack 112 via the pressure gage 132, the flow meter 130, and the valve 128. The anode gas fed and used in the stack is discharged as anode exhaust gas from the anode side gas discharge port 134.

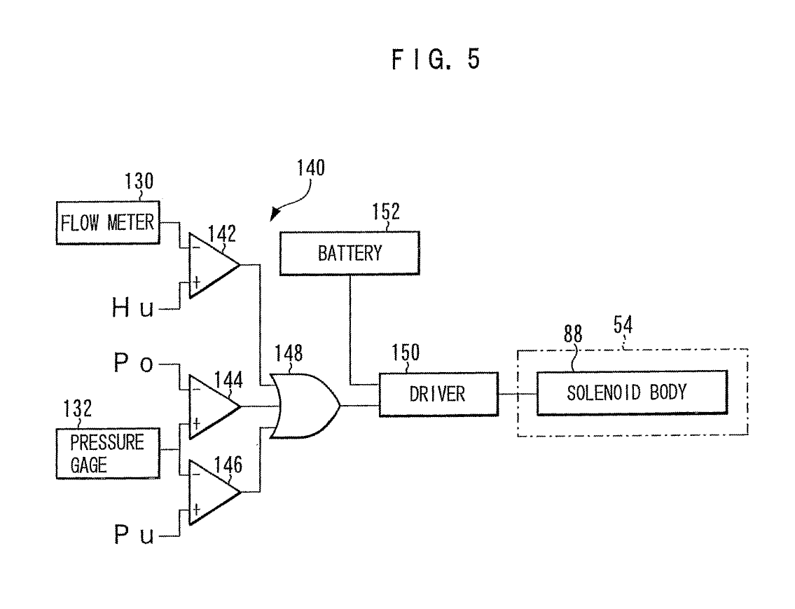

Referring to FIG. 5, there is schematically shown, in a block diagram, the structure of a solenoid control device 140 which can be comprehended as control means, or valve control means and anode gas control means. The solenoid control device 140 includes a plurality of comparators 142, 144, and 146.

The flow meter 130 is connected to the comparator 142 such that a flow rate signal Hs outputted from the flow meter 130, which corresponds to the flow rate of the anode gas (hydrogen gas), is inputted to one input terminal of the comparator 142. Further, a preset lower-limit flow rate value Hu is inputted to the other input terminal of the comparator 142.

The flow rate signal Hs and the lower-limit flow rate value Hu are compared in the comparator 142 such that when the flow rate of the anode gas which is based on the flow rate signal Hs is higher than the flow rate of the anode gas which is based on the lower-limit flow rate value Hu, a low-level signal is outputted from the output terminal of the comparator 142; while when the flow rate of the anode gas which is based on the flow rate signal Hs is higher than the flow rate of the anode gas which is based on the lower-limit flow rate value Hu, a high-level signal is outputted from the output terminal of the comparator 142.

Further, the pressure gage 132 is connected to one input terminal of the comparator 144 and to one input terminal of the pressure gage 132 such that a pressure signal Ps corresponding to the pressure of the anode gas passing through the pressure gage 132 is inputted to both the comparators 144 and 146.

A preset upper-limit pressure value Po is inputted to the other input terminal of the comparator 144. The pressure signal Ps and the upper-limit pressure value Po are compared in the comparator 144 such that when the pressure of the anode gas which is based on the pressure signal Ps is lower than the pressure of the anode gas which is based on the upper-limit pressure value Po, a low-level signal is outputted from the output terminal of the comparator 144; while when the pressure of the anode gas which is based on the pressure signal Ps is higher than the pressure of the anode gas which is based on the upper-limit pressure value Po, a high-level signal is outputted from the output terminal of the comparator 144.

In contrast thereto, a preset lower-limit pressure value Pu is inputted to the other input terminal of the comparator 146. The pressure signal Ps and the lower-limit pressure value Pu are compared in the comparator 146 such that when the pressure of the anode gas which is based on the pressure signal Ps is lower than the pressure of the anode gas which is based on the lower-limit pressure value Pu, a low-level signal is outputted from the output terminal of the comparator 146; while when the pressure of the anode gas which is based on the pressure signal Ps is higher than the pressure of the anode gas which is based on the lower-limit pressure value Pu, a high-level signal is outputted from the output terminal of the comparator 146.

The respective output terminals of the respective comparators 142, 144, and 146 are connected to a 3-input OR gate such that when a high-level signal is outputted from at least one of the comparators 142, 144 or 146 and inputted to the OR gate 148, a high-level signal is outputted from the OR gate.

Further, the OR gate 148 is connected to a driver 150. The driver 150 is connected to the solenoid body 88 of the solenoid 54 and also to a battery 152 such that it interrupts power supply to the solenoid body 88 when the high-level signal outputted from the OR gate 148 is inputted thereto.

Further, although not shown in FIG. 5, the driver 150 is structured such that it starts power supply to the solenoid body 88 when the valve 128 is opened while it releases power supply to the solenoid body 88, irrespective of the state of the valve 128, when a high-level signal is inputted from the OR gate 148 thereto.

Next, the operation and effect of the pressure-reducing valve 10 will be explained through a description of the operation of the fuel cell system 110.

The fuel cell system 110 is structured such that when the pump 116 is operated, air is sucked in by the pump 116 via the filter 120 and the flow meter 118 and the air sucked in by the pump 116 is fed as cathode gas into the stack 112 from the cathode side gas feed port 114.

On the other hand, when the valve 128 is opened at about that time when the pump 116 is operated, power supply to the solenoid body 88 is started by the driver 150. When the solenoid body 88 is energized, a magnetic field is generated around and inside the solenoid body 88, and the core 90 is magnetized by the magnetic field. Due to the core 90 being magnetized, the base portion 94 of the plunger 92 made of a ferromagnetic material is attracted to the core 90.

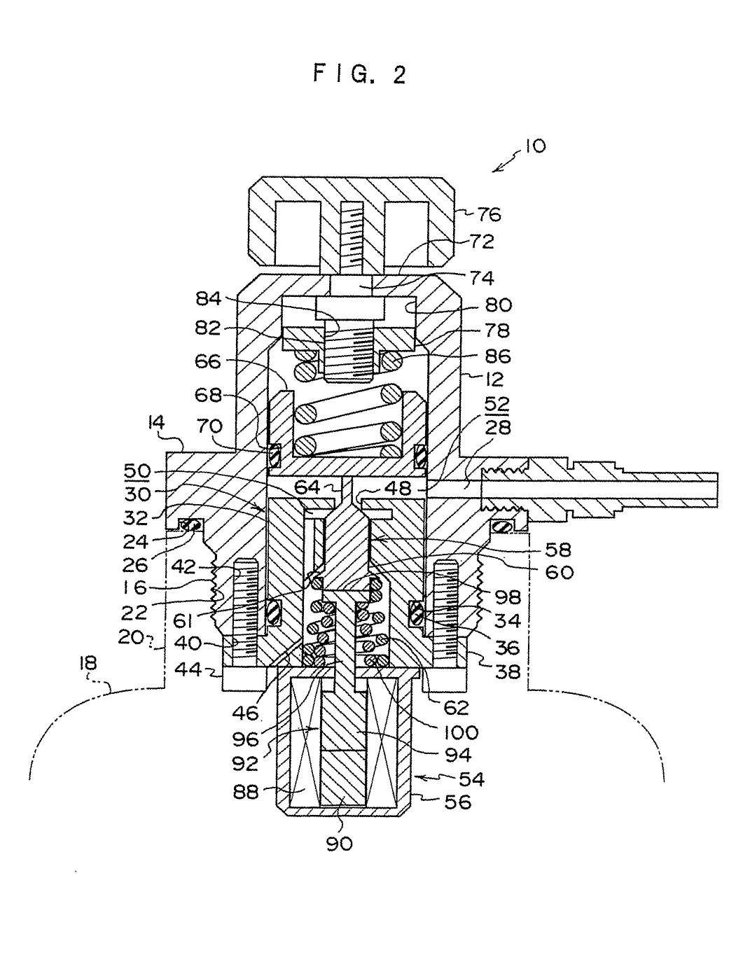

Thus, as shown in FIG. 2, the plunger 92 is caused to descend against the third biasing force of the shut spring 100. Accordingly, in this state, the third biasing force of the shut spring 100 is prevented from working on the valve body 58 via the plunger 92.

Further, when the valve 128 is opened, the hydrogen gas in the tank 18 is passed through the passage aperture of the pressure-reducing valve 10. The high-pressure hydrogen gas passed through the passage aperture 48 acts on the valve body 58 as the primary pressure P1 in the primary pressure chamber 50.

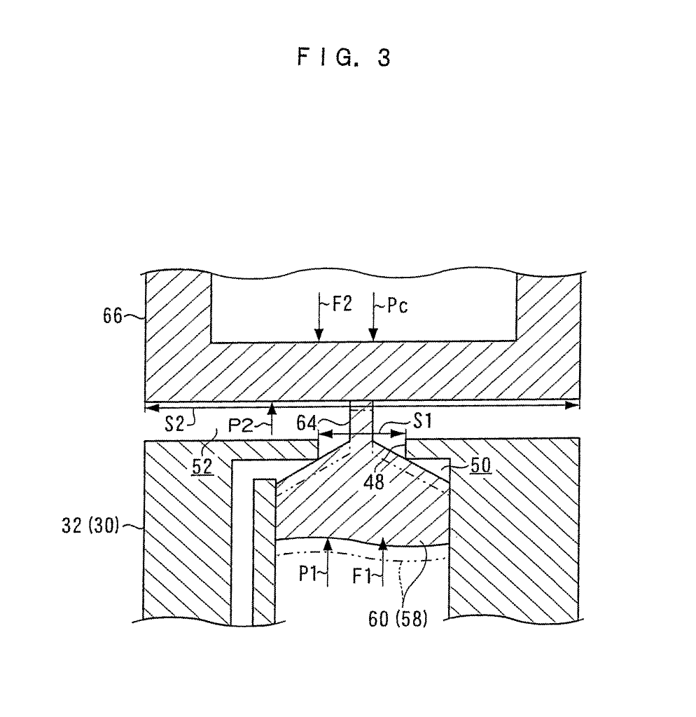

As shown in FIG. 3, a pressure Pa equal to a product of the primary pressure P1 and the valve area S1 corresponding to the opening area of the passage aperture 48 (that is, Pa=P1×S1) works on the valve body 58.

Further, the valve body 58 is pressed toward the passage aperture 48 due to a primary pressure side composite force Fx which is equal to a sum of the pressure P1 and the first biasing force F1 of the valve supporting spring 62.

The valve body 58 pressed due to the primary pressure side composite force Fx pushes upward the lower surface of the piston 66 via the pressed piece 64. Further, the second biasing force F2 of the pressure regulating spring 86 works on the piston 66 in a direction opposite to the primary pressure side composite force Fx.

When the second biasing force F2 of the pressure regulating spring 86 is greater than the primary pressure side composite force Fx, the valve 58 is pushed downward through the pressed piece 64 due to the second biasing force F2 of the pressure regulating spring 86 against the primary pressure side composite force Fx (the state indicated by a two-dot chain line in FIG. 3). Thus, the passage aperture 48 is opened so that hydrogen gas is permitted to flow toward the secondary pressure chamber 52 from the primary pressure chamber 50 through the passage aperture 48.

The hydrogen gas which has flowed toward the secondary pressure chamber 52 is passed to the exterior of the pressure-reducing valve 10 (i.e., the exterior of the tank 18) through the feed portion 28. The hydrogen gas passed to the exterior of the pressure-reducing valve 10 is fed as anode gas into the tack 112 from the anode side gas feed portion 126 through the pressure gage 132 and the flow meter 130.

When the hydrogen gas is fed as anode gas into the stack 112 and the air is fed as cathode gas into the stack 112 as above, hydrogen ions (H⁺) and electrons (e⁻) are produced from hydrogen molecules (H₂) in the catalytic layer located at the anode side of the electrolyte membrane. The hydrogen ions are permitted to permeate through the electrolyte membrane and reach the catalytic layer located at the cathode side of the electrolyte membrane.

On the other hand, the electrons form a current which flows to a load 136 shown in FIG. 4 via an external circuit, and the current is used as power for the load 136. In the cathode side catalytic layer, an electrochemical reaction is caused by the hydrogen ions having permeated through the electrolyte membrane, oxygen molecules (O₂) in the air, and the electrons having reached the cathode side catalytic layer via the external circuit from the load 136, and consequently, water is produced.

The water thus produced is discharged from the cathode side gas discharge portion 124 together with cathode exhaust gas which is the air after the electrochemical reaction has finished.

On the other hand, when hydrogen gas flows from the primary pressure chamber 50 to the secondary pressure chamber 52 as above, the pressure of the hydrogen gas having flowed in the secondary pressure chamber 52 works as the secondary pressure P2 on the piston 66, as shown in FIG. 3. Thus, a force equal to a product of the difference between the area S2 of the lower surface of the piston 66 and the opening area S1 of the passage aperture 48 and the secondary pressure P2 (i.e., Pb=(S2−S1)×P2) works on the piston 66 as a force to push the piston 66 upward.

Further, the second biasing force F2 of the pressure regulating spring 86 and an atmospheric pressure Pc between the piston 66 and the upper base portion 72 of the body 12 work on the piston 66 in a manner to counteract the pressure Pb. Accordingly, in this state, the secondary pressure side composite force Fy, which is equal to a sum of the secondary pressure P2, the second biasing force F2, and the atmospheric pressure Pc, works on the piston 66.

When the secondary pressure P2 is increased as a result of the hydrogen gas flowing from the primary pressure chamber 50 into the secondary pressure chamber 52, the secondary pressure side composite force Fy is decreased. As the secondary pressure side composite force Fy is decreased, the secondary pressure side composite force Fy becomes unable to counteract the primary pressure side composite force Fx so that the piston 66 is pressed by the pressed piece 64 of the valve body 58 so as to be pushed upward. Thus, as the piston and the valve body 58 move upward, the passage aperture 48 is partially or entirely closed by the valve body 58.

When the passage aperture 48 is partially or entirely closed by the valve body 58 as above, the flow of the hydrogen gas from the primary pressure chamber 50 into the secondary pressure chamber 52 is stopped or decreased so that the secondary pressure P2 is reduced. When the secondary pressure side composite force Fy is increased due to the secondary pressure P2 being reduced, the secondary pressure side composite force Fy counteracts the primary pressure side composite force Fx and pushes down the valve body 58 via the pressed piece 64.

Consequently, the passage aperture 48 is partially or entirely opened. In this manner, the hydrogen gas is passed to the exterior of the pressure-reducing valve 10 (the exterior of the tank 18) at the secondary pressure P2 which is sufficiently reduced as compared with the primary pressure P1 so as to be fed into the stack 112.

Meanwhile, when the valve 128 is closed in order to stop the fuel cell system 110, the flow path for the hydrogen gas between the tank 18 and the valve 128 is closed so that the secondary pressure P2 is increased.

When the secondary pressure side composite force Fy is decreased due to secondary pressure P2 being increased, the piston 66 is pressed by the pressed piece 64 of the valve body so as to be pushed up. Thus, as the piston 66 and the valve body 58 move up, the passage aperture 48 is closed by the valve body 58.

In such a state, if a gap is formed between the valve body 58 and the passage aperture 48, the hydrogen gas is caused to leak from the primary pressure chamber 50 side to the secondary pressure chamber 52 side through the gap. Thus, the secondary pressure P2 is increased so that the valve body 58 is further moved upward. Basically, when the passage aperture 48 is closed by the valve body 58, the flow rate value Hs of the hydrogen gas detected at the flow meter 118 becomes lower than the lower-limit set value Hu.

Consequently, a high-level signal is outputted from the comparator 142. When the high-level signal outputted from the comparator 142 is inputted to the OR gate 148, a high-level signal is outputted from the OR gate 148. The high-level signal outputted from the OR gate 148 is inputted to the driver 150 which in turn interrupts the power supply to the solenoid body 88.

Due to the power supply to the solenoid body 88 being interrupted, the magnetic field formed around and inside the solenoid body 88 is eliminated, and concomitantly the magnetization of the core 90 is released. Due to the magnetization of the core 90 being released, the attraction of the base portion 94 of the plunger 92 by the core 90 is released so that the plunger 92 is moved upward due to the third biasing force F3 of the shut spring 100, as shown in FIG. 1.

The plunger 92 thus moved up has its pressing portion 98 placed in contact with the valve body 58 (main body 60) so that the valve body 58 is pushed up from below due to a pressing force based on the third biasing force F3 of the shut spring 100. Due to the valve body 58 being pushed up as above, the upper end of the valve body 58 is placed in close contact with the inner circumference of the passage aperture 48, and the passage aperture is thereby closed.

Due to the passage aperture being closed as above, leakage of the hydrogen gas (leakage of the gas pressure) from the primary pressure chamber 50 to the secondary pressure chamber 52 can be prevented with certainty so that a careless pressure increase on the secondary pressure chamber 52 side can also be positively prevented. Since an unintentional pressure increase in the secondary pressure chamber 52 when the valve 128 is closed can be prevented, as above, it is possible to prevent high-pressure hydrogen gas from being unintentionally fed as anode gas to the stack 112 when the valve 128 is opened again, and thus it is possible to positively prevent the stack 112 or the like from being damaged due to high-pressure hydrogen gas being unintentionally fed into the stack 112.

On the other hand, even though the flow rate value Hs of the hydrogen gas detected at the flow meter 118 does not become lower than the lower-limit set value Hu as above, it is possible that the hydrogen gas at the primary pressure chamber 50 side leaks to the secondary pressure chamber 52 side through the gap between the passage aperture 48 and the valve body 58 so that the secondary pressure P2 is increased. The secondary pressure P2 is detected by the pressure gage 132, and a pressure signal Ps based on the result of the detection (based on the magnitude of the secondary pressure P2) is outputted from the pressure gage 132.

The pressure signal Ps outputted from the pressure gage 132 is inputted to the comparator 144. When the increased secondary pressure P2 exceeds the pressure based on the preset upper-limit pressure value Po, due to leakage of the hydrogen gas from the primary pressure chamber 50 side to the secondary pressure chamber 52 side, a high-level signal is outputted from the comparator 144.

When the high-level signal outputted from the comparator 144 is inputted to the OR gate 148, a high-level signal is outputted from the OR gate 148. The high-level signal outputted from the OR gate 148 is inputted to the driver 150 which interrupts the power supply to the solenoid body 88 in response thereto.

Therefore, as in the case where the flow rate value Hs of the hydrogen gas detected by the flow meter 118 is lower than the lower-limit set value Hu, the power supply to the solenoid body 88 is interrupted, and the valve body 58 is pushed up from below by the pressing portion 98 of the plunger 92 which is moved upward due to the third biasing force F3 of the shut spring 100. Thus, as mentioned above, the passage aperture 48 is closed by the valve body 58 so that leakage of the hydrogen gas (leakage of the gas pressure) from the primary pressure chamber 50 to the secondary pressure chamber 52 can be prevented with certainty and thus an unintentional pressure increase on the secondary pressure chamber 52 side can also be prevented with certainty.

Meanwhile, the pressure signal Ps outputted from the pressure gage 131 is inputted not only to the comparator 144 but also to the comparator 146. The pressure signal Ps inputted to the comparator 146 is compared with the preset lower-limit pressure value Pu, and when the secondary pressure P2 becomes lower than the lower-limit pressure value Pu, a high-level signal is outputted from the comparator 146.

When the high-level signal outputted from the comparator 146 is inputted to the OR gate 148, a high-level signal is outputted from the OR gate 148. The high-level signal outputted from the OR gate 148 is inputted to the driver 150 which interrupts the power supply to solenoid body 88 in response thereto.

Thus, the valve body 58 is pushed up from below by the pressing portion 98 of the plunger 92 moved up due to the third biasing force F3 of the shut spring 100.

Here, in case a quantity of hydrogen gas which by rights should not flow, but does flow due to some abnormality for example, the secondary pressure P2 is extraordinarily reduced. In the pressure-reducing valve 10, when the secondary pressure P2 becomes lower than the pressure based on the above-mentioned lower-limit pressure value Pu, the valve body 58 is forcibly pushed up by the pressing portion 98 of the plunger 92 due to the third biasing force F3 of the shut spring 100.

Due to the valve body 58 being forcibly pushed up as above, the passage aperture 48 is forcibly closed by the valve body 58, irrespective of the magnitudes of the primary pressure side composite force Fx and secondary pressure side composite force Fy and the difference therebetween. Thus, it is possible to prevent a larger quantity of hydrogen gas than a predetermined quantity from flowing due to malfunction or damage of the pressure-reducing valve 10 or other portion.

Further, the pressure-reducing valve 10 is structured such that the pressing force of the plunger 92 which is based on the third biasing force F3 is imparted to one valve body 58 to which the first biasing force F1 of the valve supporting spring 62 is applied. For this reason, the present pressure-reducing valve 10 can be made far more compact than a conventional structure in which a pressure-reducing valve and a regulator are simply arranged and combined with each other, and can be applied as a so-called “in-tank type” pressure-reducing valve which is mounted to the mouth ring portion 20 of the tank 18.

Although in the present embodiment, the pressure-reducing valve 10 has been illustrated and described by way of example as applied to the fuel cell system 110, the pressure-reducing valve 10 is by no means limited to the application to a fuel cell system, and finds a wide range of applications in which a high-pressure fluid is to be delivered in a pressure-reduced state.

When the fuel cell system 110 is mounted on a motor vehicle and used as a driving energy source of the motor vehicle, the larger the volume of hydrogen gas stored in the tank 18 is, the more preferable it is, but it is also preferable that the dimensions of tank 18 be small. When such points are taken into account, it is likely that pressure of the hydrogen gas contained in the tank 18 becomes extremely high and thus the difference between the pressure in the tank 18 and the pressure of the hydrogen gas delivered to the stack 112 becomes large.

In such a structure, it is very effective to apply the present pressure-reducing valve 10 which is capable of positively preventing leakage of hydrogen gas from the primary pressure chamber 50 side to the secondary pressure chamber 52 side due to the passage aperture 48 being hermetically closed by the valve body 58 being pushed up from below by the pressing portion 98 in a state in which the passage aperture 48 is closed by the valve body 58 as above.

In addition, as above, since the present pressure-reducing valve 10 can be made far more compact than a conventional structure in which a pressure-reducing valve and a regulator are simply arranged and combined, and since it can be applied as a so-called “in-tank type” pressure-reducing valve which is mounted to the mouth ring portion 20 of the tank 18, the present pressure-reducing valve 10 can contribute to decreasing the size of the fuel cell system 110 from this point of view as well.

Further, in the present embodiment, the conditions when the power supply to the solenoid body 88 is interrupted by the solenoid control device 140 are at least one of the following three conditions: when the flow rate of the hydrogen gas flowing in the stack 112 becomes lower than or equal to the preset lower-limit flow rate value Hu; when the pressure of the hydrogen gas flowing in the stack 112 becomes higher than or equal to the upper-limit pressure value Po; and when the pressure of the hydrogen gas flowing in the stack 112 becomes lower than or equal to the lower-limit pressure value Pu. However, the conditions when the power supply to the solenoid body 88 is interrupted may just be any one or two of the above-mentioned three conditions, and alternatively may be a condition or conditions other than the above three conditions.

Further, although in the present embodiment, the solenoid control device 140 has been structured so as to include the comparators 142, 144, and 146 with the OR gate 148 as above, it is also possible that a structure may be adopted in which software-wise control is performed by software using a program that determines if a condition or conditions such as mentioned above are satisfied and without using the comparators 141, 144, andl46 with the OR gate 148, for example.

Next, description will be made of a second embodiment of the present invention. Meanwhile, parts basically identical to those of the first embodiment are indicated by identical reference numerals, and further description thereof will be omitted.

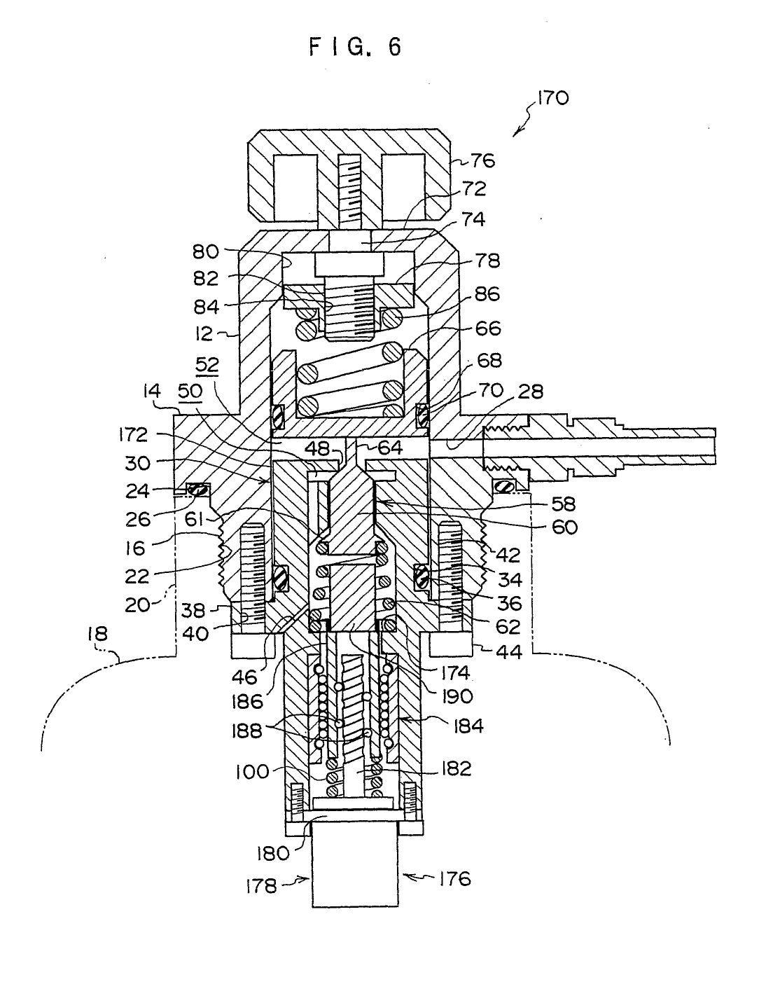

Referring to FIG. 6, there is shown a sectional view of the structure of a pressure-reducing valve 170 according to this embodiment.

As shown in FIG. 6, the pressure-reducing valve 170 includes a frame 172 in lieu of the frame 32. As in the case of the frame 32, the valve body 58 and the valve supporting spring 62 are accommodated inside the frame 172. However, unlike the frame 32, the frame 172 has a middle bottom portion 174 provided at a vertically middle portion thereof, and the lower end portion of the spring supporting spring 62 is placed on the middle bottom portion 174.

Further, the pressure-reducing valve 170 includes as driving means a motor actuator 176 which constitutes interfering means. The motor actuator 176 includes a motor 178. On the outer peripheral portion of a motor housing or yoke forming the motor 178 is provided a flange portion 180 which closes a lower opening end of the frame 172.

An output shaft 182 of the motor 178 is accommodated inside the frame 172 below the middle bottom portion 174. Further, a linear guide 184 is provided inside the frame 172. The linear guide 184 includes a cylindrical tube body 186 whose inner diameter is larger than the outer diameter of the output shaft 182 and which is disposed coaxially with respect to the output shaft 182 in a state accommodating the output shaft 182 therein.

Screw grooves are formed in the inner circumference of the tube body 186 and the outer circumference of the output shaft 182, respectively, and plural balls 188 are disposed between the screw grooves. Specifically, it is structured that a ball screw is formed by the output shaft 182, the tube body 186, and the plural balls 188 such that the tube body 186 is slid downward in response to rotation in one direction of the output shaft 182 about its own axis

Further, a shut spring 100 is interposed between the lower end of the tube body 186 and the upper end of the motor housing or yoke of the motor 178. That is, in this embodiment, it is the tube body 186 and not the plunger 92 that is biased upward due to the third biasing force F3 of the shut spring 100. Further, the upper end portion of the tube body 186 penetrates through the middle bottom portion 174, and a round column-shaped pressing portion 190 is integrally fixed to the upper end portion of the tube body 186 below the main body 60 of the valve body 58 and in opposing relationship to the lower surface of the main body 60.

Thus, in the pressure-reducing valve 170 according to this embodiment, when the motor 178 is operated such that the output shaft 182 is rotated in one direction about its own axis, the tube body 186 of the linear guide 184 is moved downward against the third biasing force P3 of the shut spring 100.

When the motor 178 is stopped, the shut spring 100 causes the output shaft 182 to be rotated in the other direction while pushing up the tube body 186 with the third biasing force F3 thereof. Consequently, the pressing portion 190 is moved upward so as to be placed in contact with the lower surface of the valve body 58 (the lower surface of the main body 60), and the valve body 58 is pushed up due to a pressing force based on the third biasing force F3 of the shut spring 100.

As will be appreciated from the above discussion, the pressure-reducing valve 170 according to this embodiment is different from the pressure-reducing valve 10 according to the foregoing first embodiment in terms of the structure of the driving means. However, the pressure-reducing valve 170 according to this embodiment performs substantially the same operation as the pressure-reducing valve 10 according to the first embodiment as far as it is concerned that the valve body 58 is pushed up from below by the pressing portion 190 provided in place of the pressing portion 98, independently of by the valve supporting spring 62. Thus, the pressure-reducing valve 170 according to this embodiment can also produce an effect basically equivalent to that of the first embodiment.

Although in the respective embodiments described above, a structure has been adopted in which the valve body 58 is pushed up by the pressing portion 98 or 190 with the third biasing force F3 of the shut spring 100, it is also possible that a structure may be alternatively adopted, for example, in which the valve body 58 is pushed up in response to the pressing portion 98 or 190 being moved upward due to the magnetic field generated by the solenoid body 88 or due to the rotational force of the motor 178, instead of the valve body 58 being pushed up due to a biasing force of biasing means such as the shut spring 100. In such an alternative structure, an additional spring may be provided for the purpose of causing the pressing portion 98 or 190 to be spaced apart from the valve body 58.

Further, although in respective embodiments described above, the driving means is structured using the solenoid 54 and the motor 178, the structure of the driving means is by no means limited to the use of the solenoid 54 and motor 178, and the driving means may be structured with any method such that the pressing portion 98 or 190 can be moved either upward or downward.

1. A pressure-reducing valve, comprising:
a valve body provided at a more upstream position from a passage aperture through which a fluid flows, as viewed in a direction of the fluid flow, in a manner to be movable into and out of contact with the passage aperture, the valve body being structured so as to be biased toward the passage aperture due to a first biasing force directed toward the passage aperture and moved in a direction to approach the passage aperture due to a primary pressure side composite force resulting from a combination of the force due to a primary pressure which is a pressure of the fluid at a more upstream position than the passage aperture and the first biasing force, thereby closing the passage aperture;
a pressure regulating member provided at a downstream position from the passage aperture as viewed in the direction of the fluid flow and on an opposite side to the valve body across the passage aperture in a manner so as to be movable toward and away from the passage aperture, the pressure regulating member being structured so as to be biased due to a second biasing force directed in a direction toward the passage aperture and causing the valve body to be spaced apart from the passage aperture when a secondary pressure side composite force resulting from a combination of the second biasing force and the resultant force due to the pressure difference between a secondary pressure which is a pressure of the fluid at a more downstream position of the fluid flow than the passage aperture and the atmospheric pressure, exceeds the primary pressure side composite force; and
interfering means capable of interfering and releasing the interference with the valve body and restricting movement of the valve body in a direction spacing apart from the passage aperture in a state of interference with the valve body.

2. The pressure-reducing valve according to claim 1, wherein the interfering means presses the valve body toward the passage aperture in a state of interference with the valve body.

3. The pressure-reducing valve according to claim 1, wherein the interfering means comprises:
an interfering member provided in a manner so as to be movable into and out of contact with the valve body at a side of the valve body opposite to the passage aperture along a direction that the valve body is moved into and out of contact with the passage aperture, the interfering member being structured so as to contact and interfere with the valve body through movement in a direction approaching the valve body; and
driving means for moving the interfering member in at least one of a direction approaching the valve body or a direction departing from the valve body.

4. (canceled)

5. The pressure-reducing valve according to claim 3, further comprising biasing means that causes the interfering member to be biased either in a direction approaching the valve body or in a direction departing from the valve body, wherein the driving means causes the interfering member to be moved only in a direction substantially opposite to the direction in which the interfering member is biased by the biasing means.

6. (canceled)

7. The pressure-reducing valve according to claim 1, wherein the interfering means interferes with the valve body in at least one of the states from the group consisting of a state in which a flow rate of the fluid passing through the passage aperture is equal to or lower than a preset predetermined value, a state in which the pressure at the downstream side of the passage aperture is higher than a predetermined value, and a state in which the pressure at the downstream side of the passage aperture is lower than a predetermined value.

8. (canceled)

9. (canceled)

10. (canceled)

11. (canceled)

12. (canceled)

13. A pressure-reducing valve, comprising:
a valve body provided at a more upstream position from a passage aperture through which a fluid flows, as viewed in a direction of the fluid flow, in a manner to be movable into and out of contact with the passage aperture, the valve body being structured so as to be biased toward the passage aperture due to a first biasing force directed toward the passage aperture and moved in a direction to approach the passage aperture due to a primary pressure side composite force resulting from a combination of the force due to a primary pressure which is a pressure of the fluid at a more upstream position than the passage aperture and the first biasing force, thereby closing the passage aperture;
a pressure regulating member provided at a downstream position from the passage aperture as viewed in the direction of the fluid flow and on an opposite side to the valve body across the passage aperture in a manner so as to be movable toward and away from the passage aperture, the pressure regulating member being structured so as to be biased due to a second biasing force directed in a direction toward the passage aperture and causing the valve body to be spaced apart from the passage aperture when a secondary pressure side composite force resulting from a combination of the second biasing force and the resultant force due to the pressure difference between a pressure of the fluid at a more downstream position of the fluid flow than the passage aperture and the atmospheric pressure, exceeds the primary pressure side composite force; and
interfering means capable of interfering and releasing the interference with the valve body and restricting movement of the valve body in a direction spacing apart from the passage aperture in a state of interference with the valve body, the interfering means comprising:
an interfering member provided in a manner so as to be movable into and out of contact with the valve body at a side of the valve body opposite to the passage aperture along a direction that the valve body is moved into and out of contact with the passage aperture, the interfering member being structured so as to contact and interfere with the valve body through movement in a direction approaching the valve body, and
driving means for moving the interfering member in at least one of a direction approaching the valve body or a direction departing from the valve body.

14. A pressure-reducing valve, comprising:
a valve body provided at a more upstream position from a passage aperture through which a fluid flows, as viewed in a direction of the fluid flow, in a manner to be movable into and out of contact with the passage aperture, the valve body being structured so as to be biased toward the passage aperture due to a first biasing force directed toward the passage aperture and moved in a direction to approach the passage aperture due to a primary pressure side composite force resulting from a combination of the force due to a primary pressure which is a pressure of the fluid at a more upstream position than the passage aperture and the first biasing force, thereby closing the passage aperture;
a pressure regulating member provided at a downstream position from the passage aperture as viewed in the direction of the fluid flow and on an opposite side to the valve body across the passage aperture in a manner so as to be movable toward and away from the passage aperture, the pressure regulating member being structured so as to be biased due to a second biasing force directed in a direction toward the passage aperture and causing the valve body to be spaced apart from the passage aperture when a secondary pressure side composite force resulting from a combination of the second biasing force and the resultant force due to the pressure difference between a pressure of the fluid at a more downstream position of the fluid flow than the passage aperture and the atmospheric pressure, exceeds the primary pressure side composite force; and
interfering means capable of interfering and releasing the interference with the valve body and restricting movement of the valve body in a direction spacing apart from the passage aperture in a state of interference with the valve body, the interfering means comprising:
an interfering member provided in a manner so as to be movable into and out of contact with the valve body at a side of the valve body opposite to the passage aperture along a direction that the valve body is moved into and out of contact with the passage aperture, the interfering member being structured so as to contact and interfere with the valve body through movement in a direction approaching the valve body, and
driving means for moving the interfering member in at least one of a direction approaching the valve body or a direction departing from the valve body wherein the interfering means presses the valve body toward the passage aperture in a state of interference with the valve body
wherein biasing means that causes the interfering member to be biased either in a direction approaching the valve body or in a direction departing from the valve body, wherein the driving means causes the interfering member to be moved only in a direction substantially opposite to the direction in which the interfering member is biased by the biasing means; and
wherein the interfering means interferes with the valve body in at least one of the states from the group consisting of a state in which a flow rate of the fluid passing through the passage aperture is equal to or lower than a preset predetermined value, a state in which the pressure at the downstream side of the passage aperture is higher than a predetermined value, and a state in which the pressure at the downstream side of the passage aperture is lower than a predetermined value.

15. The pressure-reducing valve of claim 14 wherein the interfering means interferes with the valve body in all of a state in which a flow rate of the fluid passing through the passage aperture is equal to or lower than a preset predetermined value, a state in which the pressure at the downstream side of the passage aperture is higher than a predetermined value, and a state in which the pressure at the downstream side of the passage aperture is lower than a predetermined value.

16. The pressure-reducing valve of claim 14 wherein the interfering means interferes with the valve body in all of a state in which a flow rate of the fluid passing through the passage aperture is equal to or lower than a preset predetermined value, a state in which the pressure at the downstream side of the passage aperture is higher than a predetermined value, a state in which the pressure at the downstream side of the passage aperture is lower than a predetermined value and at least one other state.

17. The pressure-reducing valve according to claim 2, wherein the interfering means interferes with the valve body in at least one of the states from the group consisting of a state in which a flow rate of the fluid passing through the passage aperture is equal to or lower than a preset predetermined value, a state in which the pressure at the downstream side of the passage aperture is higher than a predetermined value, and a state in which the pressure at the downstream side of the passage aperture is lower than a predetermined value.

18. The pressure-reducing valve according to claim 3, wherein the interfering means interferes with the valve body in at least one of the states from the group consisting of a state in which a flow rate of the fluid passing through the passage aperture is equal to or lower than a preset predetermined value, a state in which the pressure at the downstream side of the passage aperture is higher than a predetermined value, and a state in which the pressure at the downstream side of the passage aperture is lower than a predetermined value.

19. The pressure-reducing valve according to claim 5, wherein the interfering means interferes with the valve body in at least one of the states from the group consisting of a state in which a flow rate of the fluid passing through the passage aperture is equal to or lower than a preset predetermined value, a state in which the pressure at the downstream side of the passage aperture is higher than a predetermined value, and a state in which the pressure at the downstream side of the passage aperture is lower than a predetermined value.
